(19) United States
(12) Patent Application Publication
(10) Pub. No.: US 2025/0247587 A1
(43) Pub. Date: Jul. 31, 2025

(54) SYSTEMS AND METHODS FOR LARGE INTERCONNECTED ENVIRONMENTS

(71) Applicants: DISH Network L.L.C., Englewood, CO (US); DISH Network Technologies India Private Limited, Bengaluru, Karnataka (IN)

(72) Inventors: Joshua D. Wade, Castle Rock, CO (US); Jason Anthony Madruga, Castle Rock, CO (US); Clark Hurst Pendery, Englewood, CO (US); Himanshu Jain, Bangalore (IN); Laxminarayana Dalimba, Bengaluru (IN); Sandeep Rachoori, Bangalore (IN)

(21) Appl. No.: 18/606,806

(22) Filed: Mar. 15, 2024

(30) Foreign Application Priority Data
Jan. 30, 2024 (IN) 202441006018

(51) Int. Cl. H04N 21/6405; H04N 21/41; H04W 8/00

(52) U.S. Cl. CPC H04N 21/6405; H04N 21/4126; H04W 8/005

(57) ABSTRACT

A method may include receiving, by a computing system, a signal indicating a requested user device connection, the computing system connected to a first network. In response to the signal indicating the requested user device connection, the method may include enabling, by the computing system, a mode characterized by generating, by the computing system, an identification message may include a status of the computing system and an identifier of the computing system. The mode may also be characterized by transmitting, by the computing system, the identification message to a computing device connected to the first network. The mode may also be characterized by receiving, by the computing system, a list of the other active computing systems connected to the first network.

### CROSS REFERENCE TO RELATED APPLICATIONS

This application claims priority to Indian Provisional Patent Application No. 202441006018, filed on Jan. 30, 2024, in the Indian Intellectual Property Office, the disclosure of which is incorporated by reference in its entirety for all purposes.

This application is related to Indian Provisional Patent Application No. 202441004769, filed on Jan. 23, 2024, in the Indian Intellectual Property Office, the disclosure of which is incorporated by reference in its entirety for all purposes.

### BACKGROUND

Various protocols are utilized to enable device-to device connections, such as video casting. In smaller networks, these protocols may be lightweight—not requiring large amounts of bandwidth. In larger networks, however, these protocols may result overwhelm various network resources, leading to service degradation and/or network failures.

### BRIEF SUMMARY

A method may include receiving, by a computing system, a signal indicating a requested user device connection, the computing system connected to a first network. In response to the signal indicating the requested user device connection, the method may include enabling, by the computing system, a mode characterized by generating, by the computing system, an identification message may include a status of the computing system and an identifier of the computing system. The mode may also be characterized by transmitting, by the computing system, the identification message to a computing device connected to the first network. The mode may also be characterized by receiving, by the computing system, a list of the other active computing systems connected to the first network.

In some embodiments, the mode may be enabled according to a default setting. The method may include receiving, by the computing system, instructions that when executed by the computing system, cause the computing system to be reconfigured such that the computing system is configured to transmit an identification message to the computing device according to the default setting. The signal indicating the requested user device connection may be received in response to a user input. The computing system may be designated as a central source, and the method may include receiving, by the computing system, one or more identifying messages indicating other active computing systems connected to the first network. The method may include generating, by the computing system, a list may include the other active computing systems connected to the first network. The method may include broadcasting, by the computing system, the list via the first network. The computing system may operate according to a multicast domain name system (MDNS).

In some embodiments, the method may include connecting, by the computing system, to a user device. The method may include receiving, by the computing system and from the user device, data to be displayed. The method may include generating, by the computing system, an image based on the data received from the user device. The method may include causing, by the computing device, the image to be displayed. The signal may be received from a second computing device, and the computing system may transmit the identification messages for a predetermined time period.

A system may include one or more processors and a computer-readable memory including instructions that, when executed by the one or more processors, cause the system to perform operations. According to the operations, the system may receive a signal indicating a requested user device connection, the signal received via a first network. In response to the signal indicating the potential user device connection, the system may enable a mode such that the system may generate an identification message that may include a status of the computing system, an identifier of the computing system, and a request for a list of other active computing systems connected to the first network. The system may transmit the identification message to a computing device connected to the first network. The system may receive the list of the other active computing systems connected to the first network.

In some embodiments, the system may further include a display. The system may connect to a user device. The system may then receive data to be displayed from the user device. The system may generate an image based on the data received from the user device. The system may cause the image to be displayed by the display. The system may be connected to the one or more other active systems via the first network and is connected to a second computing device via a second network. The system may transmit an internet protocol multicast to the one or more other active systems via the first network. The system may connect to a user device via a third network. The system may include a set top box connected to a television. The system may include an internet of things (IOT) device. The signal may be received from a remote control associated with the system. The signal may be received from a second computing device, and the computing system may transmit the identification messages for a predetermined time period. The system may include a sensor and the signal may be received from the sensor. The system may be designated as a central source. The system may then receive one or more identifying messages indicating other active computing systems connected to the first network. The system may generate a list may include the other active computing systems connected to the first network; and broadcast the list via the first network.

A set top box may include a casting module configured to receive data from a user device and display an image on a display connected to the set top box. The set top box may include a communications module configured to communicate with one or more other set top boxes using a multicast domain name system (MDNS) protocol. The set top box may include a processor and a computer-readable memory including instructions that, when executed by the one or more processors, cause the set top box to perform operations. According to the operations, the set top box may receive a signal indicating a requested user device connection, the signal received via a first network. In response to the signal indicating the potential user device connection, the set top box may enable a mode wherein the set top box may generate an identification message may include a status of the computing system, an identifier of the computing system, and a request for a list of other active computing systems connected to the first network. The set top box may transmit the identification message to a computing device connected to the first network. the set top box may receive the list of the other active computing systems connected to the first network.

### BRIEF DESCRIPTION OF THE DRAWINGS

FIG. 1 illustrates a system and a method for providing video from a user device to a receiver, according to certain embodiments.

FIG. 2 illustrates a system for providing identification messages by receivers, according to certain embodiments.

FIG. 3 illustrates a system for a centralized list for use in a multi-receiver system, according to certain embodiments.

FIG. 4 illustrates a set top box for receiving data from a user device 406 and displaying images on a television, according to certain embodiments.

FIG. 5 illustrates a flowchart of a method for receiving data from a user device, according to certain embodiments.

FIG. 6 illustrates a flowchart of a method for receiving data from a user device, according to certain embodiments.

### DETAILED DESCRIPTION

Media consumption habits have changed over time as more and more options for consuming media have been presented. Basic over-the-air television gave way to cable television, which in turn has made way for various streaming services. Users now have a wide variety of options for media consumption, where each user may have their own preferences, desires, etc. Furthermore, a user may have media on an associated user device that they wish to access via another device such as a television.

In order to accommodate these user preferences, devices and systems may allow the user device to transmit the media (or “cast”) so that the media can be displayed on some device other than the user device. For example, a receiver may be connected to a television. The receiver may not only provide access to one or more media content types (e.g., cable, web-based streams, etc.), but may also allow the user device to cast to the receiver. Similar functionality may be provided by other network devices (e.g., a router, computer, etc.), or built into a television itself.

Commonly, receivers with casting capabilities may operate using multicast domain name system protocols (mDNS) to keep track of various hostnames on a local network connected to the receivers. According to mDNS, a receiver may broadcast (or “multicast”) a message on the local network that identifies the receiver to all other receivers on the local network. This mDNS functionality may generally be enabled at all times that the receiver is turned on. It may be desired to know which devices are active on the local network at any given time. The receiver may also receive a list of all the receivers on the local network. Furthermore, the user device may utilize mDNS to identify and connect with a particular receiver on the local network. For example, the user device may receive the list of all the receivers on the local network and select the particular receiver from the list using a service name provided via mDNS. The user device may then select a receiver and connect to (and cast) to the particular receiver over the local network (or some other network).

In small local networks, mDNS may cause minimal or no issues. The network traffic of a small network may generally be much lower than the total bandwidth available of the network. A small local network may only have a handful of receivers. By contrast, other local networks may include several receivers, each using mDNS. The cumulative effect on network traffic of the receivers using mDNS may cause network slowdowns and/or failures due to heavy traffic. This heavy traffic may further be exacerbated by a plurality of user devices also communicating over the local network. Additionally, although receivers and casting are used in the examples above (and herein), similar issues may arise from any device using mDNS for any purpose. For example, many Internet of Things (IoT) devices may use mDNS for similar local network identification and hostname purposes. Other protocols besides mDNS may also be used and may lead to similar issues. Thus, there is a need to manage mDNS (or other protocols) in a network including a plurality of receivers and/or other devices.

One solution may include altering the receiver (or other devices) to only utilize mDNS in response to a trigger. For example, a receiver may be initially configured to utilize mDNS. The receiver may then be modified to default to not use mDNS (or at least to not to broadcast a status). Thus, when the receiver is powered on, but not casting or preparing to cast, the receiver may not broadcast identification messages to a local network. The receiver may then receive a signal indicating that a user device (e.g., a cell phone, laptop, etc.) may connect with the receiver. The receiver may then enable mDNS, and begin broadcasting identification messages according to mDNS and/or other protocols and settings. The receiver may also then be configured to connect to the user device (e.g., for casting). The receiver may then determine that the receiver is not connected to the user device and cease operating according to mDNS. In other words, the receiver may only broadcast identification messages according to mDNS when a user device is expected to connect to the receiver. In a large local network, the receiver (and other receivers on the large network) may not use network bandwidth to send and receive messages and lists outside of casting scenarios.

Another solution may be to alter one or more receivers connected to a large local network such that a single receiver or other device transmits a list of all receivers to each of the one or more receivers connected to the local network. As in the example above, a receiver may default to not broadcasting an identification message to the local network. The receiver may then receive a signal indicating a requested user device connection. In response to the signal, the receiver may enable a mode in which the receiver generates and transmits the identification message. The identification message may include a status of the computing system, an identifier of the computing system, a request for a list of other active computing systems connected to the local network, and other such information. The receiver may then receive a list of all other active (e.g., casting or available) receivers connected to the local network. The list may be generated by a single computing device, such as a backend server or other device. The list may also be generated by the receiver itself or another receiver connected to the local network. Thus, the receiver may receive a list of all active receivers on the local network when engaged in casting, but need not transmit identification messages at other times. Because the list is being transmitted by a single source on the local network, the traffic experienced by the local network may be greatly reduced.

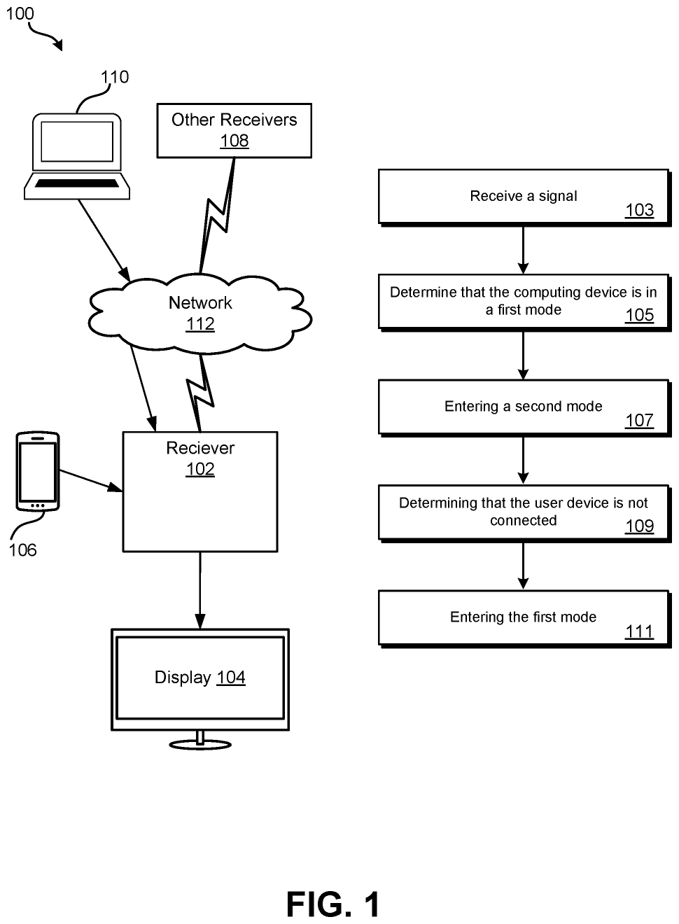

FIG. 1 illustrates a system 100 and a method 101 for providing video from a user device 106 to a receiver 102, according to certain embodiments. The system 100 may include a receiver 102, a television 104, and a user device 106. The system 100 may also include other receivers 108 and a computing device 110, accessible through a network 112. Although the system 100 is shown and described using receivers, televisions, etc., it should be understood that these are just examples. The system 100 may include other devices such as IoT devices, or any other device, in combination with and/or instead of the devices shown in FIG. 1. Furthermore, some or all of the devices shown in FIG. 1 may be combined with other devices. For example, the receiver 102 and the television 104 may be a unitary device in some embodiments (e.g., a smart TV). Also, although the network 112 is shown as a single network, there may be a plurality of networks. The receiver 102, the other receivers 108 and/or the user device 106 may communicate with one another via a first network (e.g., a local network via Wi-Fi, Bluetooth, or other suitable protocols). The receiver 102 and the computing device 110 may communicate with one another via a second network (e.g., WiFi, a wired connection etc.). The user device 106 may communicate with the receiver 102 via Bluetooth, WiFi, or some other suitable protocol.

The system 100 may represent a large local network. For example, the system 100 may be implemented in a hotel, conference center, or other setting where several users may (at least potentially) be casting to several receivers (e.g., the receiver 102 and the other receivers 108). Each of the receiver 102 and the other receivers 108 (collectively sometimes, “the receivers”) may operate using mDNS or other such protocol. The receiver 102 and the other receivers 108 may be configured initially to operate according to standard mDNS protocols. That is, each of the receivers may broadcast identification messages regularly (e.g., every 5 seconds, every 10 seconds etc.).

The receivers may include a television receiver and/or a television converter such as a set-top box (STB) or smart TV content receivers (i.e., incorporated into the television 104). In another example, the receivers may be incorporated in a computer, such as a tablet computing device; or any other computing system or device, as well as variations thereof. Further, the receivers may be able to communicate with other devices in accordance with various communication protocol(s) and/or standard(s) including, for example, TCP/IP (Transmission Control Protocol/Internet Protocol), DLNA/DTCP-IP (Digital Living Network Alliance/Digital

Transmission Copy Protection over Internet Protocol), HDMI/HDCP (High-Definition Multimedia Interface/High-bandwidth Digital Content Protection). For example, as disclosed further herein, one or more of the various elements or components of the network 112 may communicate using TCP/IP using one or more wireless techniques, such as Wi-Fi; or wired techniques, such as Ethernet or MoCA® (Multimedia over Coax Alliance). Still other embodiments are possible.

The receiver 102 may be configured to receive signals from the user device 106 as part of a casting operation. For example, the user device 106 may include a mobile phone, tablet, computer, etc. The user device 106 may be then configured to cast to a device in order to play back media content. To do so, the user device 106 may establish a connection with the device (e.g., the receiver 102) and the media may be displayed on the television 104 (or some other appropriate display). The connection may be established, at least in part, using mDNS or some other suitable protocol.

The computing device 110 may be a backend server, network resource, cloud resource, or other computing system. The computing device 110 may act perform administrative tasks associated with the receivers. In the example where the system 100 is implemented in a hotel, the computing device 110 may be a backend computer used to manage the receivers placed in guest rooms. The computing device 110 may therefore authorize access to the receiver 102 for a user associated with the user device 106. For example, the computing device 110 may authorize the receiver 102 to accept casting requests from the user device 106, authorize certain content access (e.g., pay per view events), and or perform other tasks.

At step 103, the receiver 102 may receive a signal that indicates that the user device 106 may connect to the receiver 102. The signal may be received from the computing device 110. For example, if a guest checks into a hotel, the computing device 110 may send the signal to the receiver 102 indicating that the user device 106 may connect with the receiver 102 shortly. In another embodiment, the receiver 102 may be associated with a device such as a remote control. The receiver 102 may then receive a signal from the remote control that indicates that the user device 106 may connect with the receiver 102. In yet another embodiment, the receiver 102 may receive the signal from a sensor. For example, a motion detector or other such sensor may detect motion in an area associated with the receiver 102. In response to detecting motion, the sensor may cause a signal to be sent to the receiver 102 indicating a potential user device connection. In still another embodiment, the signal may be received from the user device 106. For example, the receiver 102 may cause a QR code or other such code to be displayed on the television 104. The user device 106 may scan the QR code and then transmit the signal to the receiver 102 (e.g., via WiFi). The examples and embodiments above may occur in isolation or may combine any and all of the embodiments described. Furthermore, other possibilities and configurations would be apparent to one of ordinary skill in the art.

At step 105, the receiver 102 may determine that the receiver 102 is in a first mode. The first mode may be characterized by the receiver 102 not operating according to mDNS. In other words, mDNS may be disabled (at least partially) in a default mode. The receiver 102 may be initially configured to operate according to mDNS by default. This means that the receiver 102 may broadcast identification messages at a given interval (e.g., every 1 sec, every 5 sec, every 10 sec, etc.) by default. In order to change this default mode, instructions may be provided to the receiver 102. The instructions may cause the receiver 102 to be reconfigured such that the first mode becomes the default mode, where the identification messages are only broadcast in response to a signal indicating a potential (or on-going) connection to a user device (e.g., the user device 106).

At step 107, once the receiver 102 has received the signal, the receiver 102 may then enter a mode in which mDNS is at least partially enabled. The receiver 102 may enter the mode for a given period of time. For example, the computing device 110 may send the signal to the receiver 102, and the receiver 102 may enter the mode for a time period (e.g., 10 minutes). If, on the other hand the signal is received from a user input (e.g., a remote control, a button on the receiver, etc.), the mode may be entered for a shorter time period (e.g., 1 minute). One or ordinary skill in the art would recognize many different possibilities.

The mode may also include aspects that allow the user device 106 to connect to the receiver 102. For example, after entering the first mode (e.g., enabling mDNS), the receiver 102 may receive a request to connect with the user device 106. The receiver 102 may then receive data from the user device to be displayed. For example, the receiver 102 may receive a video stream, a file, an audio file, and or some combination thereof. The receiver 102 may then generate (or render) the received files, and cause an image to be displayed (e.g., on the television 104).

At step 109, the receiver 102 may determine that the user device 106 is not connected to the receiver 102. For example, the receiver 102 may receive a second signal that includes instructions to enter the default mode (e.g., disable mDNS) prior to a connection with the user device 106 being established. The receiver 102 may reach a timeout point without connecting to the user device 106. If the receiver 102 enables mDNS for a time period based on the signal, and no connection with the user device 106 is made, the receiver 102 may therefore determine that the user device 106 is not connected. In still other embodiments, the user device 106 may terminate the connection (e.g., after the user device 106 completes its casting operations).

At step 111, the receiver 102 may enter the default mode, disabling mDNS. Even though a potential user device connection may have been indicated, the user device 106 may have disconnected, never connected, or simply timed out (as described above). Therefore, the receiver 102 may disable some or all of the mDNS functions, saving network bandwidth.

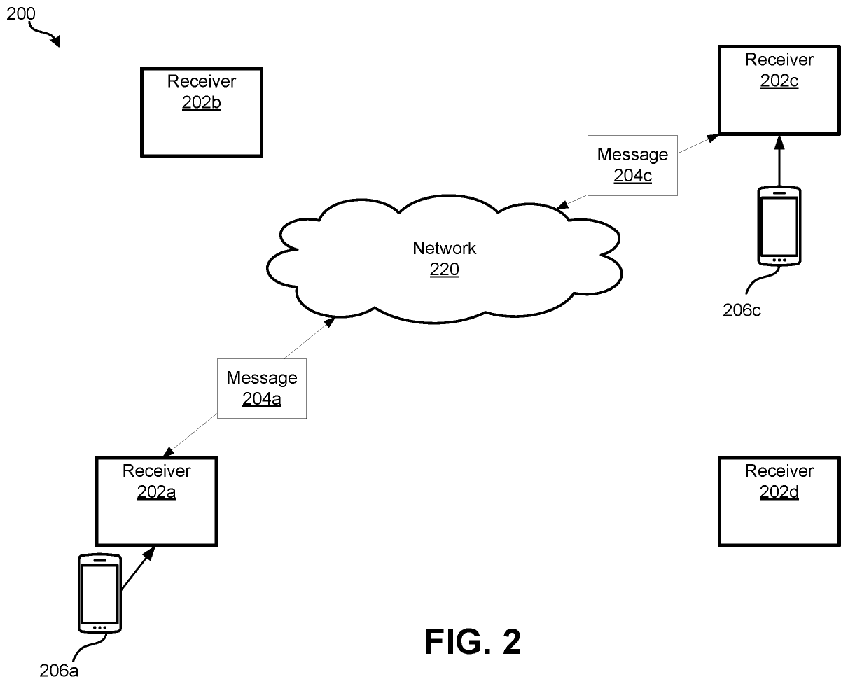

FIG. 2 illustrates a system 200 for providing identification messages 204a-c by

receivers 202a-c, according to certain embodiments. The system 200 may be similar to some or all of the system 100 described in FIG. 1. The system 200 may include receivers 202a-d, connected via a network 220. The network 220 may be a local network, used by the receivers 202a-d to communicate with one another and/or with other devices. The receivers 202a-d may be part of a large local network, where some or all of the receivers 202a-d are configured to accept casting requests from the user devices 206a and 206c.

The receivers 202a-d may be initially configured to operate according to mDNS by default. This means that the receiver 202a-d may broadcast identification messages at a given interval (e.g., every 1 sec, every 5 sec, every 10 sec, etc.) by default. In order to change this default mode, instructions may be provided to each of the receivers 202a-d. The instructions may cause the receiver 202a-d to be reconfigured such that the first mode becomes the default mode, where the identification messages are only broadcast in response to a signal indicating a potential (or on-going) connection to a user device (e.g., a corresponding user device 206a-c).

As shown in FIG. 2, the receivers 202a and 202c may be broadcasting identification messages 204a and 204c, respectively. The messages 204a-c may include information about the respective receiver 202a and 202c such as a local hostname, IP address, status, and other such information. The messages 204a-c may be received by each of the receivers 202a-d or only the active receivers connected to the network (here, receivers 202a and 202c). The receivers 202b and 202d may not broadcast identification messages, because mDNS (or another protocol) may not be activated and/or enabled on the receivers 202b and 202d.

Also as shown in FIG. 2, the receivers 202a and 202c may be connected to respective user devices 206a and 206c. The respective user devices 206a and 206c may be casting or otherwise providing data to the receivers 202a and 202c. The receivers 202a and 202c may continue to broadcast the messages 204a and 204c for the duration of the connection to the respective user devices 206a and 206 c. In some embodiments, the messages 204a and 204c may be broadcast according to a public standard or protocol. In other embodiments, the messages 204a and 204 c may be broadcast at a different interval. In still other embodiments, the messages 204a and 204c may be broadcast in response to a signal (as described in FIG. 1), upon establishing a connection with a user device, and upon termination of the connection with the user device.

For example, the receiver 202a may receive a signal indicating a potential user device connection from a computing device (e.g., the computing device 110), a user device, a remote control, a user input (e.g., a button on the receiver 202a), or some other such device. The receiver 202a may then broadcast an initial message (or series of messages) similar to the message 204a. The initial message may include a local hostname, an IP address, status (e.g., a connection is expected), and other such information. After a connection between the receiver 202a and the user device 206a is established, a second message may be broadcast updating the status to “connected.” When the connection between the receiver 202a and the user device 206a is terminated, the receiver 202a may broadcast a third message updating the status to “disconnected.” The receiver 202a may then exit the mode enabling mDNS (or other such protocol).

In the system 200, only active receivers of the receivers 202a-d may broadcast messages. Therefore, the traffic experienced by the network 220 may be drastically reduced as compared to traditional systems. Furthermore, because the active receivers 202a-d are receiving messages from all other active receivers, each of the active receivers may access a current list of the active receivers, while the inactive receivers may not saving processing power.

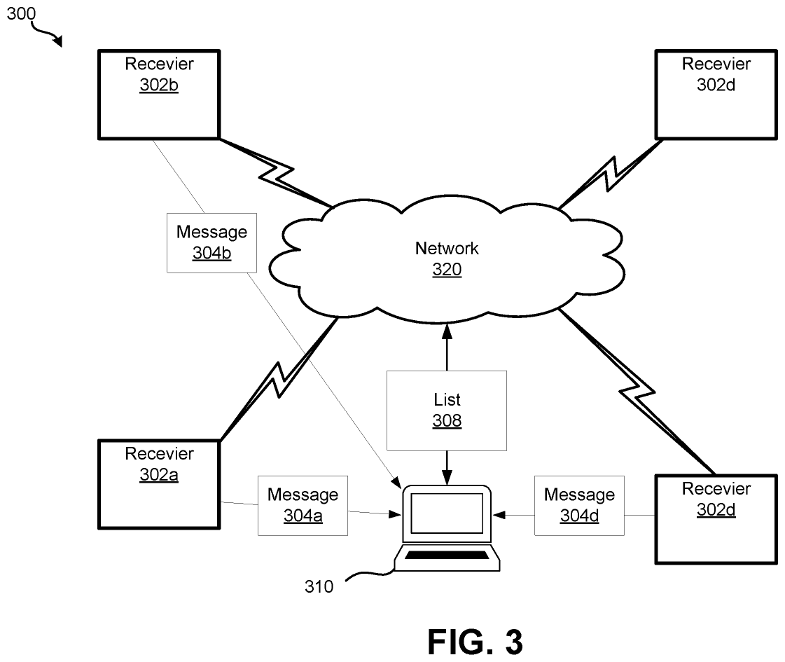

FIG. 3 illustrates a system 300 for a centralized list 308 for use in a multi-receiver system, according to certain embodiments. The system 300 may be performed by some or all of the components in the system 100. The system 300 may also be implemented in addition to or instead of the system 200 in FIG. 2. The system 300 may include receivers 302a-d, connected via a network 320. The network 320 may be a local network, used by the receivers 302a-d to communicate with one another and/or with other devices. The receivers 302a-d may be part of a large local network, where some or all of the receivers 302a-d are configured to accept casting requests from the user devices (not shown).

The receivers 302a-d may be initially configured to operate according to mDNS by default. This means that the receiver 302a-d may broadcast identification messages at a given interval (e.g., every 1 sec, every 5 sec, every 10 sec, etc.) by default. In order to change this default mode, instructions may be provided to each of the receivers 302a-d. The instructions may cause the receivers 302a-d to be reconfigured such that the first mode becomes the default mode, where the identification messages are only broadcast in response to a signal indicating a potential (or on-going) connection to a user device.

The receivers 302a-d may also be configured to transmit identification messages 304a-d to a particular destination as opposed to broadcasting the messages 304a-d via the network 320. Generally, according to mDNS, the messages 304a-d are broadcast via the network 320 to all receivers on the network. As each of the receivers 302a-d are peers (meaning there is no hierarchical structure within the network 320), the messages 304a-d may be broadcast generally without a specific (or any) destination. Each of the receivers 302a-d then receives the messages 304a-d and may generate its own list of receivers active on the network 320. As discussed above, operating in this manner in a large system may overwhelm some or all of the network 320, leading to performance degradation and/or failure of some or all of the network 320.

As shown in FIG. 3, however, the receivers 302a-d may be modified to utilize mDNS in a different way. Instead of broadcasting the messages 304a-d via the network 320, each of the receivers 302a-d may transmit a respective message 304a-d to a central source (here, a computing device 310). The respective messages 304a-d may be transmitted by default, meaning that the receivers 302a-d may operate according to mDNS by default. However, some or all of the mDNS message may be altered, such that the messages 304a-d include routing information (e.g., editing a header to include an address). In other embodiments, the messages 304a-d may be sent using a protocol other than mDNS, such that the only the central source receives all of the messages 304a-d. The messages 304a-d may be transmitted via the network 320 or by a different network.

The central source may then broadcast a list of all active receivers 302a-d to the network 320. Each of the receivers 302a-d may therefore receive a list 308 of active receivers connected to the network 320. Furthermore, user devices may be connected to the network 320. The user devices may utilize mDNS to identify and/or connect with a given receiver. Because the list 308 of active receivers is being broadcast to the network 320, the user devices may also receive the list 308 of active receivers. The user devices may then be able to identify the desired receiver and connect to the receiver for casting operations or other operations.

Although FIG. 3 illustrates the computing device 310 as broadcasting the list 308, other embodiments are also possible. For example, the receiver 302a may be designated as the central source. Each of the other receivers 302b-d may then transmit the messages 304b-d to the receiver 302a (either via the network 320 or some other network). The receiver 302a may then generate the list 308 and broadcast the list via the network 320. Each of the receivers 302a-d may also include or access a hierarchy list, including a central source order. If the receiver 302a goes offline or becomes otherwise unavailable, a new central source may be designated (e.g., the receiver 302b). Each of the receivers 302c-d may then begin transmitting the messages 304c-d to the receiver 302b, and the receiver 302b may broadcast the list 308 to the network 320. When the receiver 302a becomes available again, the receiver 302a may reassume the central source role, or may begin transmitting the message 304a to the receiver 302b. One of ordinary skill in the art would recognize many different possibilities and configurations.

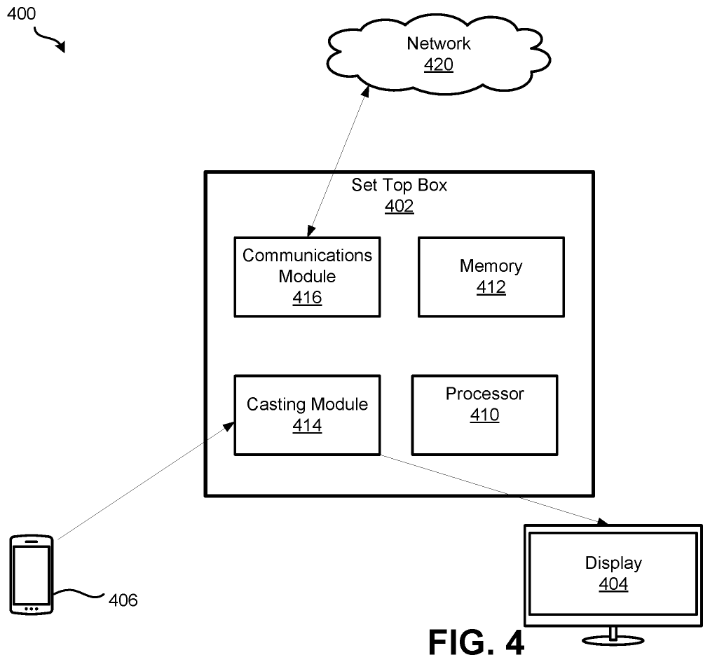

FIG. 4 illustrates a set top box 402 for receiving data from a user device 406 and displaying images on a television 404, according to certain embodiments. The set top box 402 may be similar to the receiver 102, 202, and/or 302 in FIGS. 1-3, respectively. The set top box 402 may be connected to the television 404 by one or more wired or wireless connections. In some embodiments, the set top box 402 may be integrated with the television 404. The set top box 402 may include a processor 410, a memory 412, a casting module 414, and a communications module 416. The processor 410 may perform one or more computing functions according to instructions stored on the memory 412. For example, the processor 410 may execute instructions stored on the memory 412 that cause the set top box to enter one or modes, receive and transmit signals, reconfigure one or more components of the set top box 402 and/or perform other computing functions.

The memory 412 may include a transitory and or non-transitory memory. The memory 412 may include a hard drive (HDD), solid state drive, random access memory (RAM), or any other suitable computer readable memory. The memory 412 may include instructions that cause the set top box 402 to automatically function (at least partially) according to mDNS or another such protocol. The memory 412 may then be provided with instructions that cause the set top box 402 to become reconfigured. For example, instructions may be provided that cause the set top box 402 to default to mDNS capabilities to be disabled (as is described in relation to FIG. 2). Upon receiving a signal indicating a potential user device connection, the set top box 402 may then enable some or all of the mDNS capabilities.

Additionally or alternatively, the memory 412 may be provided with instructions that cause the set top box 402 to be reconfigured to be a central unit for an mDNS set up. For example, the set top box 402 may receive identification messages from one or more other set top boxes via the network 420. The set top box 402 may then compile a list of all active set top boxes (and/or user devices) connected to the network 420. The set top box 402 may then broadcast the list to all set top boxes and/or user devices connected to the network (as is described in relation to FIG. 3).

The casting module 414 may be a hardware and/or software component of the set top box 402. The casting module 414 may be configured to connect with and receive data from a user device (e.g., the user device 406). For example, the set top box 402 may receive a signal that indicates a potential user device connection. The signal may be received from a computing device (e.g., a back end server), a user input (e.g., a button on the set top box 402), via the network 420, from the user device 406, or any other suitable means. One or ordinary skill in the art would recognize many different possibilities and configurations. In response to the signal, the processor 410 may cause the communications module 416 to begin operating according to mDNS protocols. For example, the communications module 416 may begin broadcasting and receiving identification messages via the network 420. The communications module may additionally or alternatively act as a central unit as described in FIG. 3.

The casting module 414 may then receive a connection request from the user device 406. After authenticating with the user device 406 and/or other computer systems (e.g., a back end server or service), the casting module 414 may then receive data from the user device 406. The data may include image and/or video data, audio data, or other data types. The casting module 414 may then cause some or all of the data to be displayed or otherwise output on the television 404. Upon determining that the user device 406 is no longer connected to the set top box 402, the processor 410 may cause the communications module 416 and/or the casting module to return to default settings.

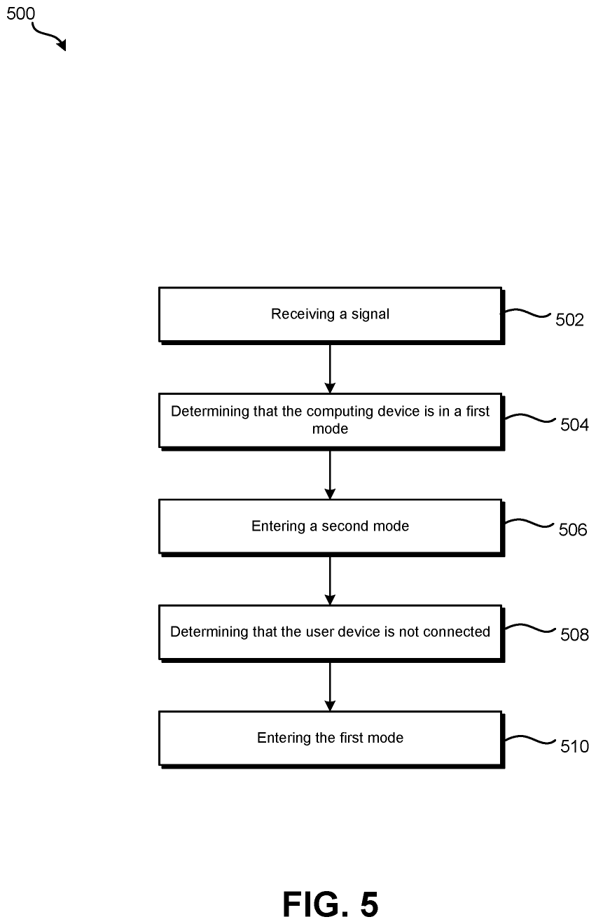

FIG. 5 illustrates a flowchart of a method 500 for receiving data from a user device, according to certain embodiments. The method 500 may be performed by any of the systems 100-400, described in FIGS. 1-4. Some of the steps of the method 500 may be performed in a different order than is shown and described, and/or may be combined with other steps. In some embodiments, some steps may be skipped altogether.

At step 502, the method 500 may include receiving, by a computing device, a signal indicating a potential user device connection. The computing device may be a receiver such as the receiver 202 in FIG. 2 and/or the set top box 402 in FIG. 4. The computing device may be integrated into another device (e.g., a smart television) or may be connected via one or more wired and/or wireless connections. The computing device may additionally or alternatively be an IoT device.

The signal may be received from a second computing device. For example, if a guest checks into a hotel, the second computing device may send the signal to the computing device, indicating that a user device may connect with the computing device. In another embodiment, the computing device may be associated with a device such as a remote control. The computing device may then receive a signal from the remote control that indicates that the user device may connect with the computing device. In yet another embodiment, the computing device may receive the signal from a sensor. For example, a motion detector or other such sensor may detect motion in an area associated with the computing device. In response to detecting motion, the sensor may cause a signal to be sent to the computing device indicating a potential user device connection. In still another embodiment, the signal may be received from the user device. For example, the computing device may cause a QR code or other such code to be displayed on the television. The user device may scan the QR code and then transmit the signal to the computing device (e.g., via WiFi).

At step 504, the method 500 may include determining, by the computing device, that the computing device is in a first mode. The first mode may be characterized by a protocol being disabled. The first mode may be characterized by the computing device not operating according to mDNS. In other words, mDNS may be disabled (at least partially) in a default mode. The computing device may be initially configured to operate according to mDNS by default. This means that the computing device may broadcast identification messages at a given interval (e.g., every 1 sec, every 5 sec, every 10 sec, etc.) by default. In order to change this default mode, instructions may be provided to the computing device. The instructions may cause the computing device to be reconfigured such that the first mode becomes the default mode, where the identification messages are only broadcast in response to a signal indicating a potential (or on-going) connection to a user device.

At step 506, the method 500 may include entering, by the computing device, a second mode. characterized by the protocol being enabled and the computing device being configured to connect to a user device. The second mode may be at least partially characterized by mDNS (or another similar protocol) being at least partially enabled. The computing device may enter the mode for a given period of time. For example, the second computing device may send the signal to the computing device, and the computing device may enter the mode for a time period (e.g., 10 minutes). If, on the other hand the signal is received from a user input (e.g., a remote control, a button on the receiver, etc.), the mode may be entered for a shorter time period (e.g., 1 minute).

One or ordinary skill in the art would recognize many different possibilities.

The mode may also include aspects that allow the user device to connect to the computing device. For example, after entering the first mode (e.g., enabling mDNS), the computing device may receive a request to connect with the user device. The computing device may then receive data from the user device to be displayed. For example, the computing device may receive a video stream, a file, an audio file, and or some combination thereof. The computing device may then generate (or render) the received files, and cause an image to be displayed (e.g., on a television).

At step 508, the method 500 may include determining, by the computing device, that the user device is not connected to the computing device. For example, the computing device may receive a second signal that includes instructions to enter the first mode (e.g., disable mDNS) prior to a connection with the user device being established. The computing device may reach a timeout point without connecting to the user device. If the computing device enables mDNS for a time period based on the signal, and no connection with the user device is made, the computing device may therefore determine that the user device is not connected. In still other embodiments, the user device may terminate the connection (e.g., after the user device completes its casting operations).

At step 510, the method 500 may include entering, by the computing device, the first mode. Even though a potential user device connection may have been indicated, the user device may have disconnected, never connected, or simply timed out (as described above). Therefore, the computing device may disable some or all of the mDNS functions, saving network bandwidth.

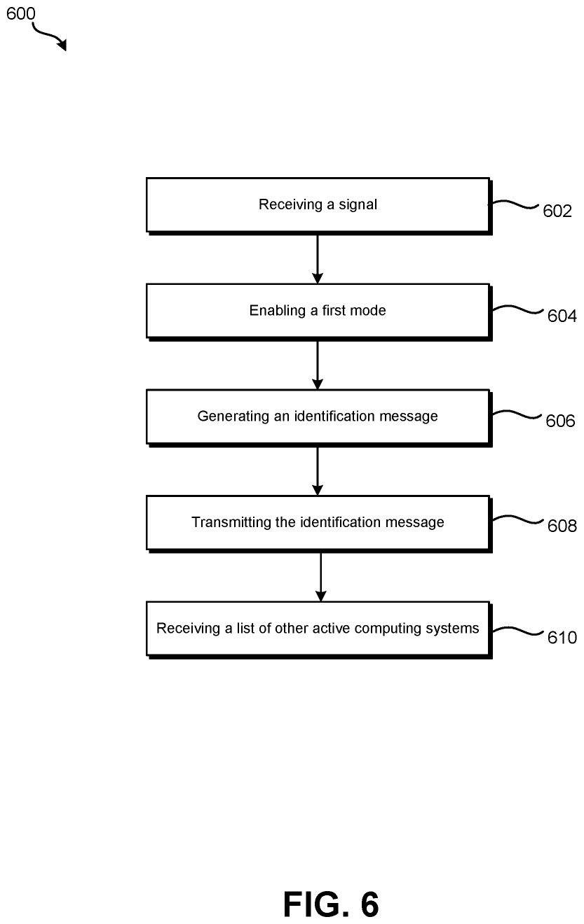

FIG. 6 illustrates a flowchart of a method 600 for receiving data from a user device, according to certain embodiments. The method 600 may be performed by any of the systems 100-400, described in FIGS. 1-4. Some of the steps of the method 600 may be performed in a different order than is shown and described, and/or may be combined with other steps. In some embodiments, some steps may be skipped altogether.

At step 602, the method 600 may include receiving, by a computing system, a signal indicating a requested user device connection, the computing system connected to a first network. The computing system may be similar to the set top box 402 in FIG. 4. The computing system may therefore be connected to and/or integrated with a television or other suitable display type. The signal may be received from a computing device. For example, if a guest checks into a hotel, the second computing device may send the signal to the computing device, indicating that a user device may connect with the computing device. In another embodiment, the computing device may be associated with a device such as a remote control. The computing device may then receive a signal from the remote control that indicates that the user device may connect with the computing device. In yet another embodiment, the computing device may receive the signal from a sensor. For example, a motion detector or other such sensor may detect motion in an area associated with the computing device. In response to detecting motion, the sensor may cause a signal to be sent to the computing device indicating a potential user device connection. In still another embodiment, the signal may be received from the user device. For example, the computing device may cause a QR code or other such code to be displayed on the television. The user device may scan the QR code and then transmit the signal to the computing device (e.g., via WiFi).

In response to the signal indicating the potential user device connection, at step 604, the method 600 may include enabling, by the computing system, a mode. According to the mode, at step 606, the method 600 may include generating, by the computing system, an identification message comprising a status of the computing system and an identifier of the computing system. The identification message may include information about the computing system such as a local hostname, IP address, status, and other information. Instead of broadcasting the identification message via the first network, the computing system to a central unit (e.g., a computing device such as a back end server) The identification message may be transmitted by default, meaning that the computing system may operate according to mDNS by default. However, some or all of the identification message may be altered, such that the identification message include routing information (e.g., editing a header to include an address). In other embodiments, the identification message may be sent using a protocol other than mDNS, such that the only the central source receives the identification messages from other active computing systems connected to the first network. The identification message may be transmitted via the first network or by a different network.

At step 608, the method 600 may include transmitting, by the computing system, the identification message to a computing device connected to the first network. The computing device may be the central source, as described above. The computing device may be a back end server, another active computing system connected to the first network (e.g., another receiver), or some other suitable device. In some embodiments, the computing system may be designated as the central source. Then, the computing system may receive identification messages from the one or more other active computing systems connected to the first network. The computing system may then generate a list of the one or more other computing systems connected to the first network and broadcast the list via the first network. At step 610, the method 600 may include receiving, by the computing system, the list of the other active computing systems connected to the first network.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method, comprising:
receiving, by a computing system, a signal indicating a requested user device connection, the computing system connected to a first network;
in response to the signal indicating the requested user device connection:
enabling, by the computing system, a mode characterized by:
generating, by the computing system, an identification message comprising a status of the computing system and an identifier of the computing system;
transmitting, by the computing system, the identification message to a computing device connected to the first network; and
receiving, by the computing system, a list of the other active computing systems connected to the first network.

2. The method of claim 1, wherein the mode is enabled according to a default setting, the method further comprising:
receiving, by the computing system, instructions that when executed by the computing system, cause the computing system to be reconfigured such that the computing system is configured to transmit an identification message to the computing device according to the default setting.

3. The method of claim 1, wherein the signal indicating the requested user device connection is received in response to a user input.

4. The method of claim 1, wherein the signal indicating the requested user device connection is received from the user device.

5. The method of claim 1, wherein the computing system is designated as a central source, the method further comprising:
receiving, by the computing system, one or more identifying messages indicating other active computing systems connected to the first network;
generating, by the computing system, a list comprising the other active computing systems connected to the first network; and
broadcasting, by the computing system, the list via the first network.

6. The method of claim 1, wherein the computing system operates according to a multicast domain name system (mDNS).

7. The method of claim 1, further comprising:
connecting, by the computing system, to a user device;
receiving, by the computing system and from the user device, data to be displayed;
generating, by the computing system, an image based on the data received from the user device; and
causing, by the computing device, the image to be displayed.

8. The method of claim 1, wherein the signal is received from a second computing device, and the computing system transmits the identification messages for a predetermined time period.

9. A system, comprising:
one or more processors; and
a computer-readable memory comprising instructions that, when executed by the one or more processors, cause the system to perform operations to:
receive a signal indicating a requested user device connection, the signal received via a first network;
in response to the signal indicating the potential user device connection:
enable a mode characterized by:
generate an identification message comprising a status of the computing system, an identifier of the computing system, and a request for a list of other active computing systems connected to the first network;
transmit the identification message to a computing device connected to the first network; and
receive the list of the other active computing systems connected to the first network.

10. The system of claim 9, wherein the system further comprises a display, and the system further performs operations to:
connect to a user device;
receive data to be displayed from the user device;
generate an image based on the data received from the user device; and
cause the image to be displayed by the display.

11. The system of claim 9, wherein the system is connected to the one or more other active systems via the first network and is connected to a second computing device via a second network.

12. The system of claim 11, wherein the system transmits an internet protocol multicast to the one or more other active systems via the first network.

13. The system of claim 11, wherein the system connects to a user device via a third network.

14. The system of claim 9, wherein the system comprises a set top box connected to a television.

15. The system of claim 9, wherein the system comprises an internet of things (IoT) device.

16. The system of claim 9, wherein the signal is received from a remote control associated with the system.

17. The system of claim 9, wherein the signal is received from a second computing device, and the computing system transmits the identification messages for a predetermined time period.

18. The system of claim 9, wherein the system comprises a sensor and the signal is received from the sensor.

19. The system of claim 9, wherein the system is designated as a central source, the system further performs operations to:
receive one or more identifying messages indicating other active computing systems connected to the first network;
generate a list comprising the other active computing systems connected to the first network; and
broadcast the list via the first network.

20. A set top box, comprising:
a casting module configured to receive data from a user device and display an image on a display connected to the set top box;
a communications module configured to communicate with one or more other set top boxes using a multicast domain name system (mDNS) protocol;
a processor; and
a computer-readable memory comprising instructions that, when executed by the one or more processors, cause the set top box to perform operations to:
receive a signal indicating a requested user device connection, the signal received via a first network;
in response to the signal indicating the potential user device connection:
enable a mode characterized by:
generate an identification message comprising a status of the computing system, an identifier of the computing system, and a request for a list of other active computing systems connected to the first network;
transmit the identification message to a computing device connected to the first network; and
receive the list of the other active computing systems connected to the first network.
